(19) United States
(12) Patent Application Publication
(10) Pub. No.: US 2007/0236936 A1
(43) Pub. Date: Oct. 11, 2007

(54) Light Source Device, Illumination Optical Device, and Display Device

(76) Inventors: Mitsuhiro Wada, Kyoto (JP); Tomoyuki Ooya, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/578,205

(22) PCT Filed: Apr. 12, 2005
(86) PCT No.: PCT/JP05/07090

§ 371 Date: Oct. 11, 2006

(30) Foreign Application Priority Data
Apr. 15, 2004 (JP) 2004-120136

(51) Int. Cl. F21V 7/04; G03B 21/28

(52) U.S. Cl. 362/298; 353/99

(57) ABSTRACT

A transmissive sealing member 18 is provided on an exit opening portion of an ellipsoidal mirror 11 and forms a sealed space inside the ellipsoidal mirror 11. A light shielding member 12a is formed on a surface of the transmissive sealing member 18 on a side of a discharge lamp 10. The ellipsoidal mirror 11 condenses the light emitted from the discharge lamp 10 and outputs the light to the outside. The light shielding member 12a shields the light, which is reflected and returns toward the discharge lamp 10, of the light emitted from the ellipsoidal mirror 11 to the outside. In this way, temperature rise of parts of the discharge lamp 10 is suppressed and reliability of a light source device 17a is improved.

### TECHNICAL FIELD

The present invention relates to a light source device which reflects light emitted from a light source and outputs the light, an illumination optical device and a display device using the light source device.

### BACKGROUND ART

Conventionally, projection type display devices using various spatial light modulating elements have been known. Such a device employs a transmissive or reflective liquid crystal panel, for example, as a spatial light modulating element to illuminate the liquid crystal panel by light sources while an optical image corresponding to a video signal supplied from the outside is formed on the liquid crystal panel. The optical image is expanded and projected on a screen by a projection lens.

In recent years, as needs for high luminance grow, three-plate type projection display devices which uses three spatial light modulating elements such as liquid panels have become dominant. However, since such a projection type display device has to employ three liquid crystal panels or the like, a problem that the cost for the entire device increases occurs.

On the other hand, a single-plate type projection display device which uses only one liquid crystal panel in order to reduce the cost is known (for example, see Japanese Laid-Open Publication No. 59-230383). However, such a projection display device has to include a color filter of three primary colors on each of pixels on the liquid crystal panels. Thus, there is a problem that a resolution is deteriorated essentially. There is also a problem that ⅔ of the illumination is lost at the color filters, and thus, the screen luminance is deteriorated.

For solving such problems, a projection display device of a color sequential method using color wheel of a disc shape as described in, for example, Japanese Laid-Open Publication No. 2000-98272 is known. In this method, one modulation element is sequentially illuminated by light of three primary colors, i.e., red, green, and blue, to display a full color image.

FIG. 15 is a schematic diagram for showing a structure of the above conventional display structure. FIG. 16 is a schematic diagram showing a structure of a color wheel shown in FIG. 15.

As shown FIG. 15, white light emitted from a discharge lamp 200 is condensed on a color wheel 203 by using an ellipsoidal mirror 201. An UV-IR cut filter 202 is used for removing ultraviolet ray and infrared ray from the emitted light from the discharge lamp 200. The color wheel 203 is formed by combining color filters 203R, 203G, and 203B which are sectors of red, green and blue into a disc shape as shown in FIG. 16. By rotating a motor 203a, light of bands of red, green and blue can be selectively transmitted sequentially.

The emitted light of the discharge lamp 200 illuminates upon a liquid crystal panel 206 through the color wheel 203, a condensing lens 204 and a field lens 205 for illumination. The color wheel 203 is rotated in synchronization with display of an image on the liquid crystal panel 206, optical images corresponding to red, green and blue video signals are displayed on the liquid crystal panel 206 in a time division manner.

The field lens 205 is used for efficiently condensing light passes through the liquid crystal panel 206 on a projection lens 207. The projection lens 207 expands the optical image on the liquid crystal panel 206 and projects on a screen (not shown). A large screen image displayed in full color is obtained. According to this method, color images with a resolution as high as that in the three-plate type device can be achieved using one liquid crystal panel. Since it is no longer necessary to provide small filters on the pixels on the liquid crystal panel 206, yield of the liquid crystal panel 206 will increase, and the cost of the projection display device can be reduced.

### DISCLOSURE OF THE INVENTION

A light source device for the projection display device as described above is required to have high reliability (long life). However, the light source of the conventional projection display device shown in FIG. 15 has problems as described below. FIG. 17 is a partially sectional view showing a structure of the light source shown in FIG. 15. FIG. 18 is an enlarged cross-sectional view of a portion cut along line A-A shown in FIG. 17.

First, there is a problem that wire may break due to oxidation of metal foil or external conductor provided in the discharge lamp and the reliability of the light source device decreases. In the discharge lamp 200 shown in FIG. 17, as shown in FIG. 18, distortion may be generated due to thermal stress between an external conductor 210 and a sealing portion 211 during sealing, and a gap is generated. Thus, the external conductor 210 and/or ends of metal foil 212 on the external conductor 210 side are in contact with air. The oxidation of these portions is promoted under an extremely high temperature condition while the lamp is lit. A time period until wire breaking happens by oxidation varies depending upon temperature. For example, when the metal foil 212 is formed using molybdenum, it takes about 2000 hours under condition of 350° C. in air.

In general, the discharge lamp 200 used in the projection display device experiences an extremely high temperature while being lit. A luminous tube 213 experiences a temperature near 1000° C. at maximum. Therefore, thermal conduction from the luminous tube 213 and thermal conduction from an electrode 214 cause a temperature near the connection portion between the metal foil 212 and the external conductor 210 to reach several hundreds degrees. By forcing air cooling by a fan or the like, the temperature can be reduced. However, if the temperature of the luminous tube 213 is also reduced, evaporation of a light emitting metal is suppressed, and light emitting efficiency is decreased. Thus, extremely local cooling is required, which is difficult. When the lamp has to be used in a sealed state, forced air cooling by a fan cannot be used.

For solving such a problem, in the conventional light source device, the metal foil has a sufficient length to put a portion of the discharge lamp which is readily oxidized as far as possible from the luminous tube. This causes the temperature rise by thermal conduction to be small and suppresses breaking of wire due to oxidation.

The white light emitted from the discharge lamp 200 is condensed on the color wheel 203 using the ellipsoidal mirror 201. For example, when the white light is condensed on the red color filter 203R on the color wheel 203, red color component passes, but green color component and blue color component are reflected and illuminate upon the sealing portion 211 of the discharge lamp 200 as returned light which further increases the temperature.

Under use circumstance where there is returned light to the light source device, the returned light illuminates upon the sealing portion 211 of the discharge lamp 200, causing the temperature of the portion to rise. Thus, there is a problem that extending the life of the conventional light source is very difficult when used under the condition where there is returned light.

An objective of the present invention is to provide a light source device, an illumination optical device and a display device with a long life and without reliability being impaired even under the condition where there is returned light to the light source device.

A light source device according to one aspect of the present invention includes: light emitting means which serves as a light source; reflecting means for reflecting light emitted from the light emitting means, and outputting the light to the outside; and light shielding means for shielding at least a part of light, which is reflected and returns toward the light emitting means, of the light emitted from the reflecting means to the outside.

In the light source device, at least a part of light, which is reflected and returns toward the light emitting means, of the light emitted from the reflecting means to the outside is shielded. Thus, even under use circumstance where there is returned light to the light source device, life of the light emitting means can be prevented from being shortened by the returned light, and a light source device with high reliability can be realized.

An illumination optical device according to another aspect of the present invention includes: the light source device described above; and light selecting means which is placed near a condensing position of light emitted from the light source device and selectively transmits light having a predetermined wavelength of the light emitted from the light source device.

In the illumination optical device, at least a part of light, which is reflected by the light selecting means and returns toward the light emitting means, of the light emitted from the reflecting means to the outside is shielded. Thus, even under use circumstance where there is returned light to the light source device, life of the light source device can be prevented from being shortened by the returned light, and a illumination optical device with high reliability can be realized.

A display device according to yet another aspect of the present invention includes: a light source device described above; forming means for forming an optical image corresponding to a video signal by using light emitted from the light source device; and projecting means for projecting the optical image formed by the forming means on a screen.

In the display device, at least a part of light, which is reflected and returns toward the light emitting means, of the light emitted from the reflecting means to the outside is shielded. Thus, even under use circumstance where there is returned light to the light source device, life of the light source device can be prevented from being shortened by the returned light, and a display device with high reliability can be realized.

### BRIEF DESCRIPTION OF THE DRAWINGS

FIG. 1 is a partially sectional view showing a structure of a light source device according to Embodiment 1 of the present invention.

FIG. 2 is a diagram of an optical path for illustrating a light shielding function in the light source device shown in FIG. 1.

FIG. 3 is a partially sectional view showing a structure of a light source device according to Embodiment 2 of the present invention.

FIG. 4 is a partially sectional view showing a structure of a light source device according to Embodiment 3 of the present invention.

FIG. 5 is a partially sectional view showing a structure of a light source device according to Embodiment 4 of the present invention.

FIG. 6 is a partially sectional view showing a structure of a light source device according to Embodiment 5 of the present invention.

FIG. 7 is a partially sectional view showing a structure of a light source device according to Embodiment 6 of the present invention.

FIG. 8 is a diagram of an optical path for illustrating a light shielding function in the light source device shown in FIG. 7.

FIG. 9 is a partially sectional view showing a structure of an illumination optical device according to Embodiment 7 of the present invention.

FIG. 10 is a schematic diagram of a color selection member shown in FIG. 9.

FIG. 11 is a schematic diagram showing a structure of a display device according to Embodiment 8 of the present invention.

FIG. 12 is a schematic diagram showing a structure of a display device according to Embodiment 9 of the present invention.

FIG. 13 is a schematic diagram showing a structure of a display device according to Embodiment 10 of the present invention.

FIG. 14 is a schematic diagram showing a structure of a display device according to Embodiment 11 of the present invention.

FIG. 15 is a schematic diagram showing a structure of a conventional projection display device.

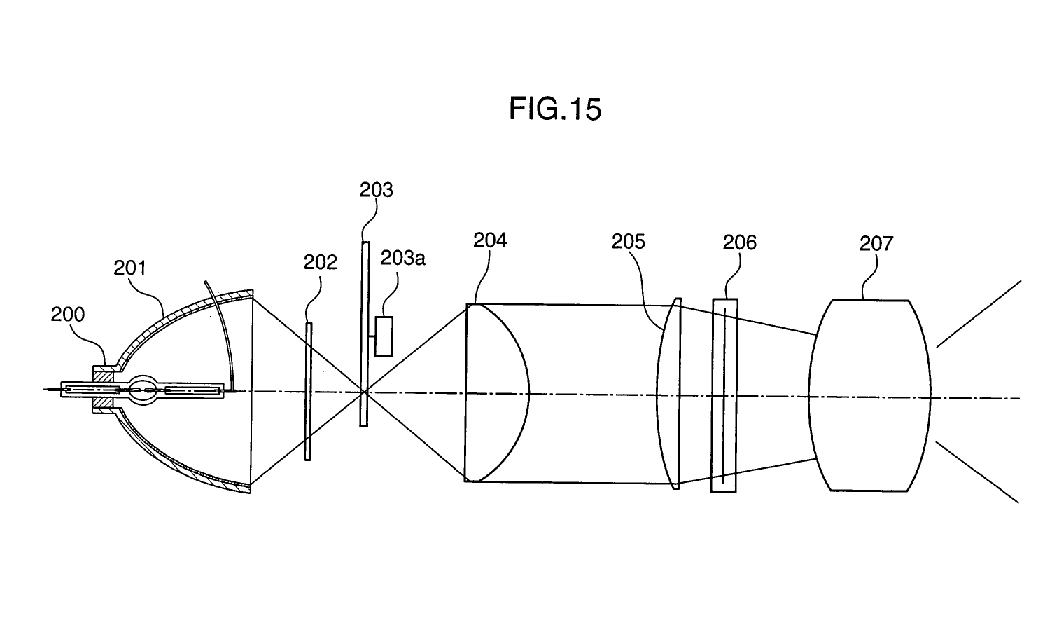

FIG. 16 is a schematic diagram showing a structure of a color wheel shown in FIG. 15.

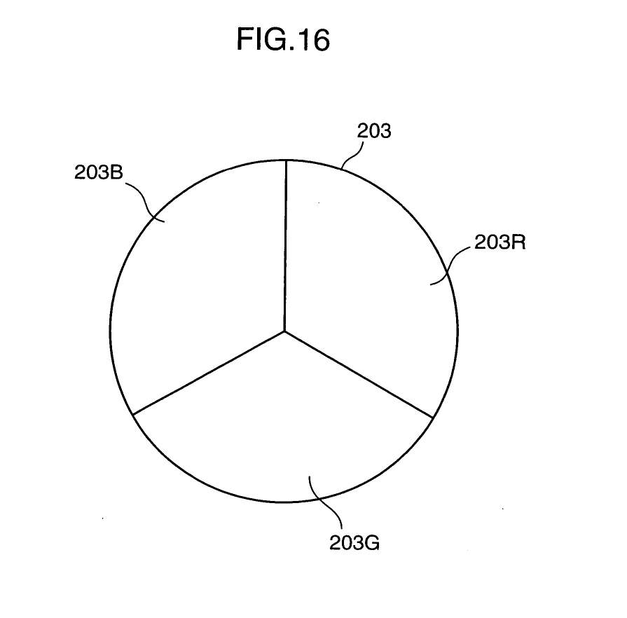

FIG. 17 is a partially sectional view showing a structure of a light source device shown in FIG. 15.

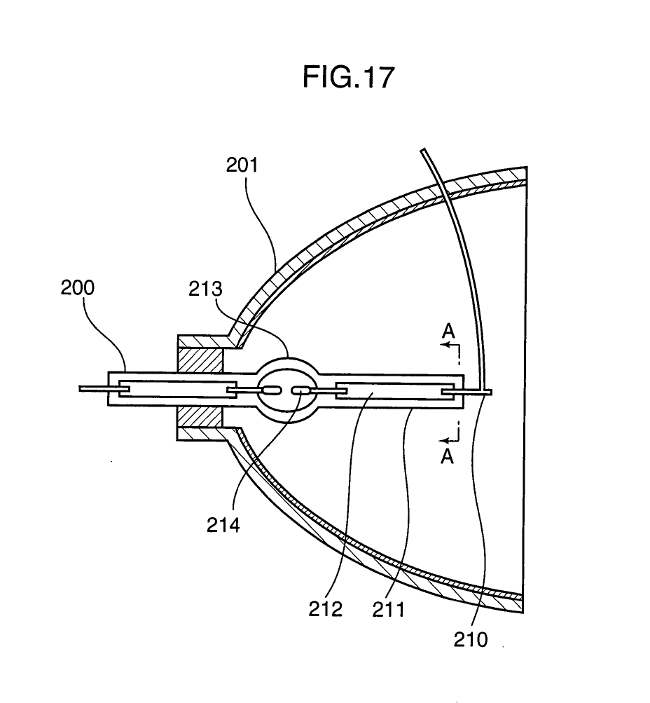

FIG. 18 is an enlarged cross-sectional view showing a portion cut along line A-A shown in FIG. 17.

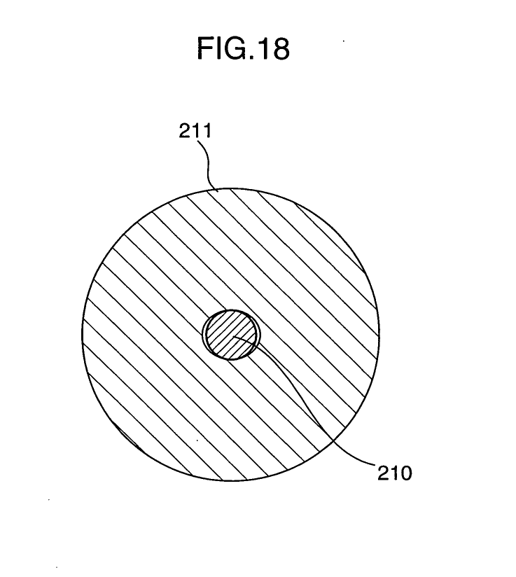

### BEST MODE FOR CARRYING OUT THE INVENTION

Hereinafter, light sources according to embodiments of the present invention, and specific embodiments when they are applied to illumination optical devices or display devices will be described with reference to the drawings.

### Embodiment 1

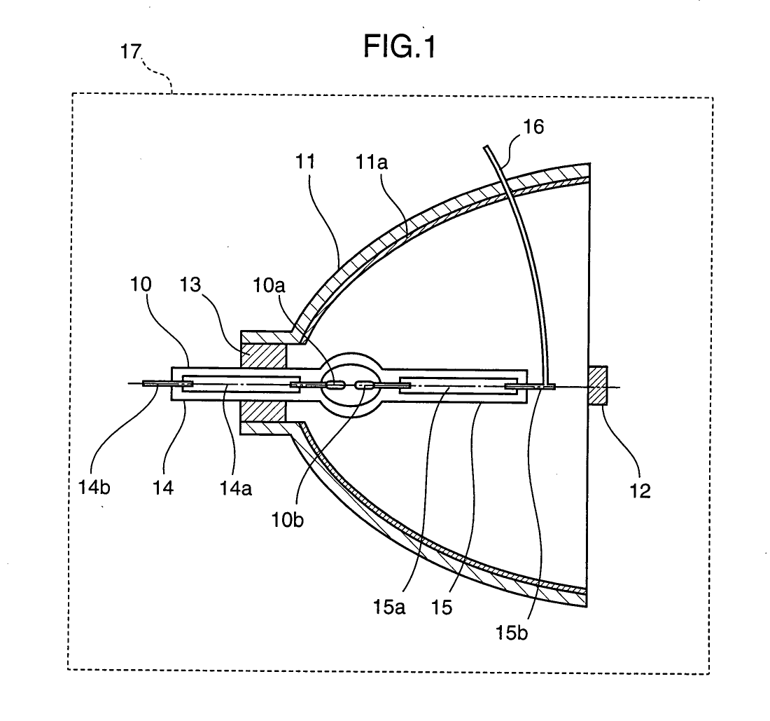

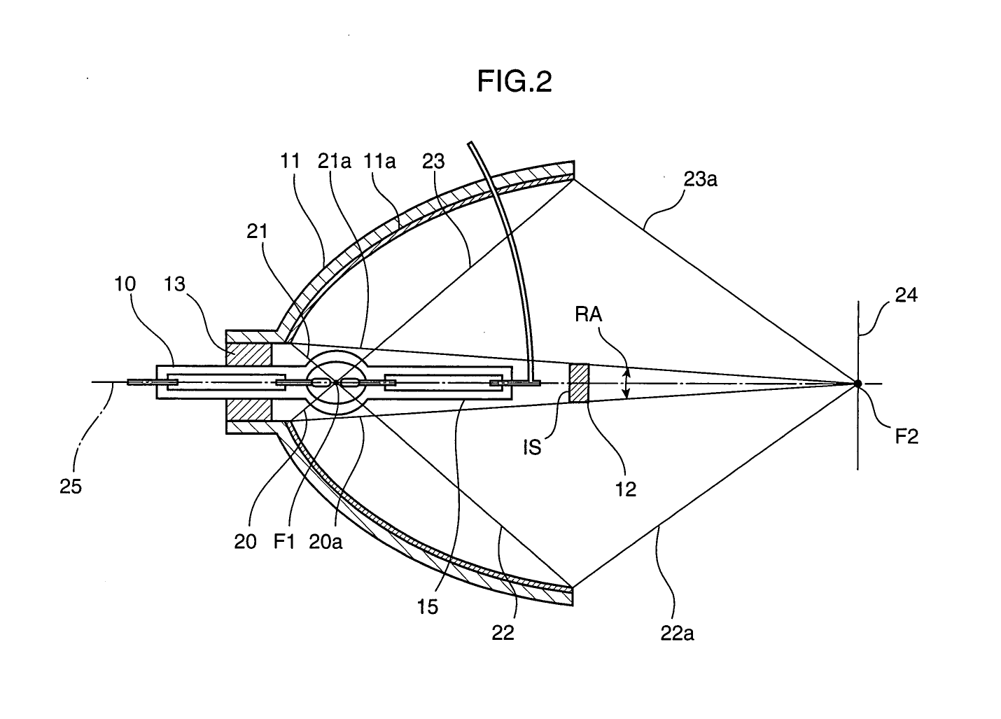

FIG. 1 is a partially sectional view showing a structure of a light source device according to a structure of a light source according to Embodiment 1 of the present invention. FIG. 2 is a diagram of an optical path for illustrating a shielding effect in the light source device shown in FIG. 1. A light source device 17 shown in FIG. 1 includes a discharge lamp 10 which is exemplary light emitting means, an ellipsoidal mirror 11 which is exemplary reflecting means and condensing means, and a light shielding member 12 which is exemplary light shielding means.

The discharge lamp 10 may be an ultrahigh pressure mercury lamp, for example. The ultrahigh pressure mercury lamp has extremely high luminance and good in condensing. Thus, light can be condensed efficiently by the ellipsoidal mirror 11. On both ends of the luminous tube of the discharge lamp 10, sealing portions 14 and 15 are provided. Metal foils 14a and 15a and lead wires 14b and 15b are sealed inside.

The metal foils 14a and 15a are formed of a metal material such as molybdenum or the like. The lead wires 14b and 15b are formed of a metal material such as tungsten or the like. Each metal is a material with high melting point and is suitable for such applications. One end of an external lead wire 16 is connected to the lead wire 15b and the other end is drawn out of the ellipsoidal mirror 11. By applying a high pressure to the external lead wire 16 and the lead wire 14b, a discharge occurs between electrodes 10a and 10b, and light is emitted. The light emitting means is not particularly limited to the above-mentioned ultrahigh pressure mercury lamp, but may be various light sources such as halogen lamp, metal halide lamp, xenon lamp and the like.

A first focal (short focus) length F1 (see FIG. 2) of the ellipsoidal mirror 11 is 10 mm. A second focal (long focus) length F2 (see FIG. 2) is 120 mm. On a reflection surface 11a of the ellipsoidal mirror 11, a dielectric multilayer film for reflecting visible light efficiently and transmitting infrared rays is formed, and a visible light component of the light emitted from the discharge lamp 10 is efficiently reflected.

In the discharge lamp 10, a center of gravity of the light emitting portion formed between the electrodes 10a and 10b is placed at about the same position as the first focus F1 (see FIG. 2) of the ellipsoidal mirror 11. The discharge lamp 10 is fixed to the ellipsoidal mirror 11 by an adhesive material 13. In this way, a condensing spot proportional to the size of the light emitting portion is formed near the second focus F2 (see FIG. 2) of the ellipsoidal mirror 11. The emitted light from the discharge lamp 10 can be efficiently condensed. The adhesive material 13 is preferably a material with a high heat resistance property. For example, inorganic heat resistant adhesives such as SUMICERAM® (available from Asahi Chemical Co., Ltd.) may be used. The light shielding member 12 is placed near an exit opening portion of the ellipsoidal mirror 11.

A light shielding effect of the light shielding member 12 will be described in detail with reference to FIG. 2. First, the light emitted from the discharge lamp 10 is reflected by the reflection surface 11a of the ellipsoidal mirror 11 in predetermined directions. More specifically, light beams 20 and 21 are respectively reflected off as light beams 20a and 21a directed to the second focus F2 of the ellipsoidal mirror 11. Similarly, light beams 22 and 23 are respectively reflected off as light beams 22a and 23a. The light beams reflected by the reflection surface 11a of the ellipsoidal mirror 11 are distributed in an area between the light beam 20a and the light beam 22a, and an area between the light beam 21a and the light beam 23a. Therefore, when the light is condensed using the ellipsoidal mirror 11, there is an area RA with no reflected light. The area RA has a substantially conical shape.

The light shielding member 12 has a disc shape, and is placed in the area RA with no reflected light. Thus, the light shielding member 12 does not shield reflected light directly from the ellipsoidal mirror 11 and can reflect a part of the reflected light which is reflected outside the light source device 17 and returns to the ellipsoidal mirror 11.

For example, when a diffusive reflection surface 24 is placed near the second focus F2 of the ellipsoidal mirror 11, a part of the light incident on the reflection surface 24 is reflected in a direction toward the ellipsoidal mirror 11 (discharge lamp 10). Of this reflected light, i.e., the light comes back to ellipsoidal mirror 11, the light shielding member 12 shields light incident on the sealing portion 15 of the discharge lamp 10. In this way, the temperature rise of the sealing portion 15 due to the returned light can be suppressed, and the reliability of the optical light source 17 can be improved.

The light shielding member 12 may be formed by forming a dielectric multilayer film for reflecting visible light on a surface of a transmissive plane glass. Light proceeds from the ellipsoidal mirror 11 toward the second focus F2 is convergence light. Thus, in the area RA with no reflected light directly from the ellipsoidal mirror 11 becomes larger as it becomes closer to the ellipsoidal mirror 11. Therefore, when the dielectric multilayer film is formed, an area of the light sealing portion becomes larger when it is formed on a surface IS close to the ellipsoidal mirror 11 and is more effective.

The light shielding member 12 also may be formed by forming a dielectric multilayer film which reflects infrared rays, a dielectric multilayer film which reflects ultraviolet rays, a dielectric multilayer film which reflects infrared rays and ultraviolet rays, or a dielectric multilayer film which reflects infrared rays, ultraviolet rays, and visible light, using glass which absorbs light of a particular wavelength, or using a medium which reflects light, such as aluminum foil, above-mentioned inorganic heat resistant adhesives (SUMICERAM®) or the like, depending upon the wavelength of the returned light. The light shielding member is not particularly limited to the above examples. Intended effects of the present invention can be achieved as long as the light shield member shields only the returned light without shielding the direct light from the ellipsoidal mirror 11.

The light shielding member 12 is preferably placed between an end of the exit opening portion of the ellipsoidal mirror 11 and an end of the sealing portion 15. However, it may be placed between the end of the exit opening portion of the ellipsoidal mirror 11 and the reflection surface 24. In such a case, it is preferable to be placed in an area closest to the ellipsoidal mirror 11 among three areas obtained by equally dividing the space into three. More preferably, it is placed in an area closest to the ellipsoidal mirror 11 among four areas obtained by equally dividing the space into four.

The size of the light shielding member 12 is preferably smaller than a size of a cross section of the area RA with no reflected light at the position where the light shielding member 12 is placed. In other words, a diameter of the light shielding member 12 is preferably smaller than a diameter of a circular cross section of the area RA. In such a case, a difference between the diameter of the light shielding member 12 and the diameter of the circular cross section of the area RA can be used as a margin for placing the light shielding member 12 to allow attachment and forming of the light shielding member 12 to be readily performed.

The diameter of the light shielding member 12 may be larger than the diameter of the circular cross section of the area RA. In this case as well, a difference between the diameter of the light shielding member 12 and the diameter of the circular cross section of the area RA can be used as a margin for placing the light shielding member 12. If there is a sufficient amount of the light reflected by the ellipsoidal mirror 11, a sufficient amount of light can be obtained even when the diameter of the light shielding member 12 is made larger than the diameter of the circular cross section of the area RA.

In the present embodiment, the light shielding member 12 is placed at a position where the center of the light shielding member 12 having a disc shape intersects an optical axis 25 of the ellipsoidal mirror 11. However, the position of the light shielding member 12 is not limited to such an example, and the center may be placed at a position which is shifted from the optical axis 25, depending upon distribution of the returned light. For example, if the reflection surface 24 is tilted from the optical axis 25 and the returned light impinges at a position shifted from the optical axis 25, the center may be placed at a position eccentric from the optical axis 25. The light shielding member 12 is placed at a position appropriately set depending upon the application.

As described above, in the present embodiment, the light shielding member 12 placed near the exit opening portion of the ellipsoidal mirror 11 shields the returned light even under the use circumstance where there is returned light to the ellipsoidal mirror 11. Thus, the temperature rise of the sealing portion 15 can be suppressed, and the light source device 17 with high reliability and the long life may be provided.

In the above description a method for fixing the light shielding member 12 is not particularly mentioned. However, various methods may be used for fixing the light shielding member 12. For example, a supporting member extending from a point of an edge of the exit opening portion of the ellipsoidal mirror 11 to the optical axis 25 may be provided and the light shielding member 12 may be fixed to the supporting member. In such a case, for avoiding the light shielding member 12 to shield the reflected light from the ellipsoidal mirror 11 unnecessarily, the supporting member is preferably placed so as to overlap with the external lead wire 16. When a supporting member extending from a point of an edge of the exit opening portion of the ellipsoidal mirror 11 to a point of the edge on the other side through the optical axis 25 is used, it is preferable that at least half the supporting member overlaps with the external lead wire 16.

### Embodiment 2

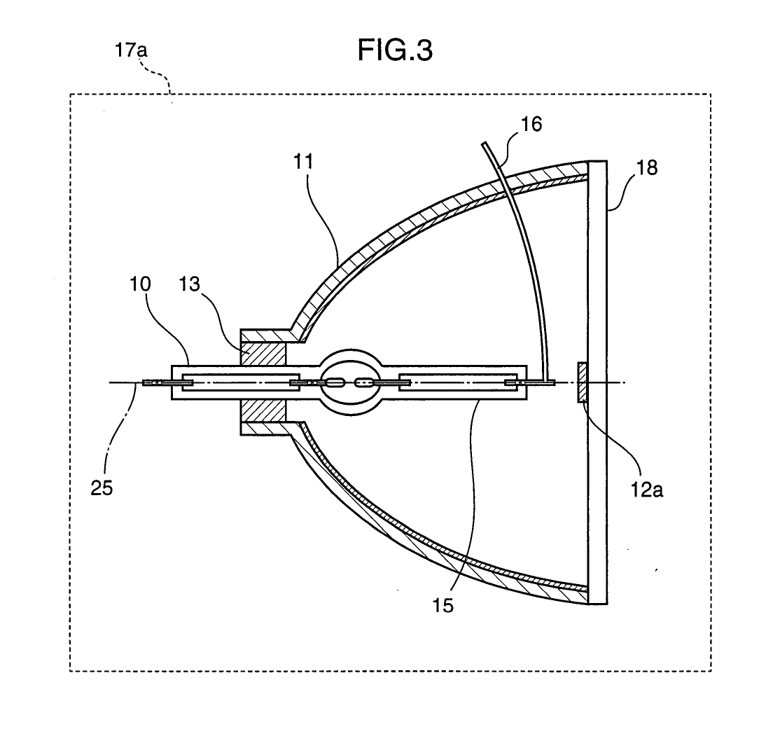

FIG. 3 is a schematic diagram showing a structure of a light source device according to Embodiment 2 of the present invention. A light source device 17a shown in FIG. 3 includes the discharge lamp 10, the ellipsoidal mirror 11, a light shielding member 12a which is exemplary light shielding means, and a transmissive sealing member 18 which is exemplary transmissive sealing means. Components same as those in Embodiment 1 are denoted by same reference numerals, and will not be further described.

The light source device 17a shown in FIG. 3 is different from the light source device 17 shown in FIG. 1 in that the transmissive sealing member 18 is placed at the exit opening portion of the ellipsoidal mirror 11, and a substantially sealed space is formed inside the ellipsoidal mirror 11. In this way, even in the case where the discharge lamp 10 is broken, glass pieces can be prevented from scattering to the outside of the light source device 17a. However, in the light source device 17a having such a structure, temperatures of the portions of the discharge lamp 10 easily rise since the sealed space is formed inside the ellipsoidal mirror 11.

For addressing this problem, in the present embodiment, as shown in FIG. 3, the light shielding member 12a is formed at a center of the transmissive sealing member 18. The light shielding member 12a is placed in a portion of the area with no reflected light. As in Embodiment 1, of the returned light re-enters the ellipsoidal mirror 11, the light shielding member 12a shields light incident on the sealing portion 15 of the discharge lamp 10 to suppress temperature rise of the portion. In this way, the reliability of the light source device 17a can be improved.

The light shielding member 12a has a disc shape, and is formed of a dielectric film which reflects visible light which is formed on a surface of the transmissive sealing member 18 on the ellipsoidal mirror 11 (discharge lamp 10) side. Light proceeds from the ellipsoidal mirror 11 toward the second focus F2 (not shown) is convergence light. Thus, the area with no reflected light directly from the ellipsoidal mirror 11 becomes larger as it is closer to the ellipsoidal mirror 11. Therefore, when the dielectric multilayer film is formed, an area of the light sealing portion can become larger when it is formed on a surface close to the ellipsoidal mirror 11, and is more effective. However, the light shielding member 12a may be placed on a surface of the transmissive sealing member 18 on the side different from that shown in FIG. 3, i.e., a surface opposite to the discharge lamp 10. Such a light shielding member may also be formed using the above-mentioned dielectric multilayer film, and, essentially, desired effects can be achieved.

The light shielding member 12a also may be formed by forming a dielectric multilayer film which reflects at least one of ultraviolet rays and infrared rays, using glass which absorbs light of a particular wavelength, or using a medium which reflects light, such as aluminum foil, above-mentioned inorganic heat resistant adhesives (SUMICERAM®) or the like, depending upon the wavelength of the returned light. The light shielding member 12a is not particularly limited to the above examples. Intended effects of the present invention can be achieved as long as the light shield member shields only the returned light without shielding the direct light from the ellipsoidal mirror 11.

In the present embodiment, the light shielding member 12a is placed at a position where the center of the light shielding member 12a having a disc shape intersects an optical axis 25 of the ellipsoidal mirror 11. However, the position of the light shielding member 12a is not limited to such an example, and the center may be placed at a position which is shifted from the optical axis 25, depending upon distribution of the returned light. The light shielding member 12a is placed at a position appropriately set depending upon the application. The transmissive sealing member is not particularly limited to plane parallel glass. Lenses having a certain power or the like may be used to form the light shielding member 12a on the lenses or the like. Alternatively, the light shielding member may be attached to a hole formed at a center of the parallel flat glass, or the transmissive sealing member and the light shielding member may be integrally formed such that the light shielding member is placed in a center of the transmissive sealing member.

As described above, in the present embodiment, the light shielding member 12a placed on the inside surface of the transmissive sealing member 18 at the exit opening portion of the ellipsoidal mirror 11 shields the returned light even under the use circumstance where there is returned light to the ellipsoidal mirror 11. Thus, the temperature rise of the sealing portion 15 can be suppressed, and the light source device 17a with high reliability and the long life may be provided.

In the present embodiment, the substantially sealed space is formed inside the ellipsoidal mirror 11. However, it does not have to be the sealed space unless it is required particularly, and a vent hole or the like may be provided.

### Embodiment 3

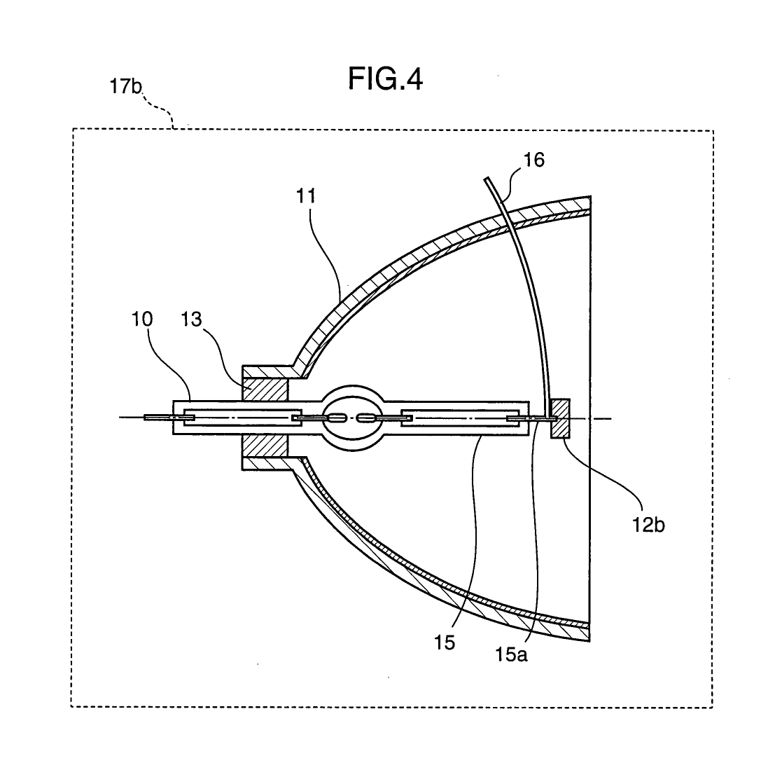

FIG. 4 is a schematic diagram showing a structure of a light source device according to Embodiment 3 of the present invention. A light source device 17b shown in FIG. 4 includes the discharge lamp 10, the ellipsoidal mirror 11, and a light shielding member 12b which is exemplary light shielding means. Components same as those in Embodiment 1 are denoted by same reference numerals, and will not be further described.

The light source device 17b shown in FIG. 4 is different from the light source device 17 shown in FIG. 1 in that the light shielding member 12b is fixed to the lead wire 15b and the external lead wire 16. The light shielding member 12b has a disc shape, and is formed by forming a dielectric multilayer film which reflects visible light on a substrate formed of transmissive plane glass, heat resistant plastic, ceramics or the like. The light shielding member 12b is fixed to the lead wire 15b and the external lead wire 16 using a highly heat-resistant adhesive or the like. The light shielding member 12b is placed in a portion of the area with no reflected light. As in Embodiment 1, of the returned light re-entering the ellipsoidal mirror 11, the light shielding member 12b shields light incident on the sealing portion 15 of the discharge lamp 10 to suppress temperature rise of the portion.

In this way, even in a light source device which does not include the transmissive sealing member 18 shown in FIG. 3, the light shielding member 12b can be stably fixed. Further, the light shielding member 12b can be placed at a position closer to the sealing portion 15 of the discharge lamp 10. Thus, a light shielding portion of the light shielding member 12b can be broadened, and heat-insulating effect can be further improved.

As described above, in the present embodiment, the light shielding member 12b fixed to the lead wire 15b and the external lead wire 16 shields the returned light even under the use circumstance where there is returned light to the ellipsoidal mirror 11. Thus, the temperature rise of the sealing portion 15 can be suppressed, and the light source device 17b with high reliability and the long life may be provided.

In the present embodiment, the transmissive sealing member 18 shown in FIG. 3 is not shown. However, the transmissive sealing member 18 may be attached as in Embodiment 2 to form a sealed space. The light shielding member 12b is not particularly limited to the above example, and the member similar to that in Embodiment 1 may be used. The attachment position of the light shielding member 12b is also not limited to the above example, and the light shielding member 12b may be fixed to one end of the sealing portion 15, or one of the lead wire 15b and the external lead wire 16.

### Embodiment 4

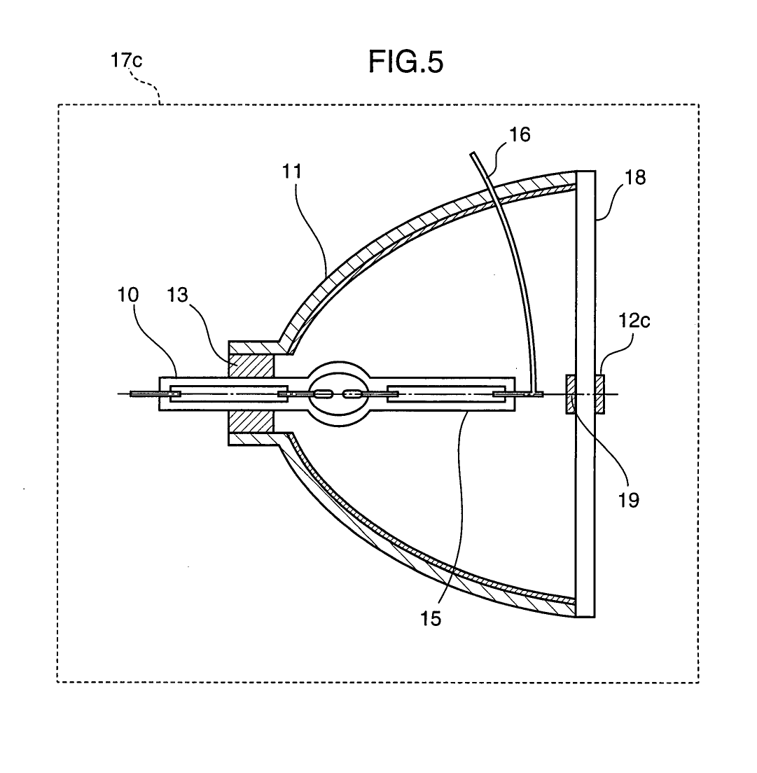

FIG. 5 is a schematic diagram showing a structure of a light source device according to Embodiment 4 of the present invention. A light source device 17c shown in FIG. 5 includes the discharge lamp 10, the ellipsoidal mirror 11, a light shielding member 12c which is exemplary light shielding means, the transmissive sealing member 18, and an absorption member 19 which is exemplary absorbing means. Components same as those in Embodiment 2 are denoted by same reference numerals, and will not be further described.

The light source device 17c shown in FIG. 5 is different from the light source device 17a shown in FIG. 3 in that the light shielding member 12c is formed on a surface of the transmissive sealing member 18 (a surface opposite to the discharge lamp 10), and the absorption member 19 is formed on a back surface of the transmissive sealing member 18 (a surface on the discharge lamp 10 side). Similarly to the light shielding member 12a of Embodiment 2, the light shielding member 12c has a disc shape and is formed of a dielectric multilayer film which reflects visible light which is formed on a surface of the transmissive sealing member 18.

The light shielding member 12c is placed in a portion of the area with no reflected light. As in Embodiment 2, of the returned light re-entering the ellipsoidal mirror 11, the light shielding member 12c shields light incident on the sealing portion 15 of the discharge lamp 10 to suppress temperature rise of the portion. In this case, the light shielding member 12c becomes farther from the ellipsoidal mirror 11 by a thickness of the transmissive sealing member 18. However, since the thickness of the transmissive sealing member 18 is thin, light shielding effect similar to that in Embodiment 2 can be achieved.

The absorption member 19 is formed by forming a black film which absorbs visible light on the back surface of the transmissive sealing member 18. The absorption member 19 is placed in a portion of the area with no reflected light, and absorbs unnecessary light passing through the portion. The unnecessary light passes through the transmissive sealing member 18 and is reflected by an external reflecting member when there is no absorption member 19. The light shielding member 12c cannot reflect this reflected light, and the temperature of the sealing portion 15 is raised. In the present embodiment, since the unnecessary light is absorbed by the absorption member 19, the temperature rise of the sealing portion 15 due to reflected light from the unnecessary light can be suppressed.

When a part of the light shielding member 12c is positioned outside the area with no reflected light, the light reflected by the ellipsoidal mirror 11 is reflected by the back surface of the light shielding member 12c (a portion outside the area with no reflected light) and illuminates the sealing portion 15 of the discharge lamp 10. In such a case, by placing the absorption member 19 at a position so as to cover the back surface of the light shielding member 12c, the light reflected by the ellipsoidal mirror 11 is not reflected by the back surface of the absorption member 19 but is absorbed by the absorption member 19. Thus, the temperature rise of the sealing portion 15 can be suppressed.

As described above, in the present embodiment, the light shielding member 12c placed on an external surface of the transmissive sealing member 18 at the exit opening portion of the ellipsoidal mirror 11 shields the returned light, and the absorption member 19 placed on an inner surface of the transmissive sealing member 18 absorbs the unnecessary light or the like even under the use circumstance where there is returned light to the ellipsoidal mirror 11. Thus, the temperature rise of the sealing portion 15 can be suppressed, and the light source device 17c with high reliability and the long life may be provided.

The absorption member 19 is not limited to the above example. Various types of the absorption member may be used as long as it can absorb unnecessary light or the like. The position is also not particularly limited to the above example. It may be integrally formed with the light shielding member 12c on the back surface of the light shielding member 12c (a surface on the transmissive sealing member 18 side).

### Embodiment 5

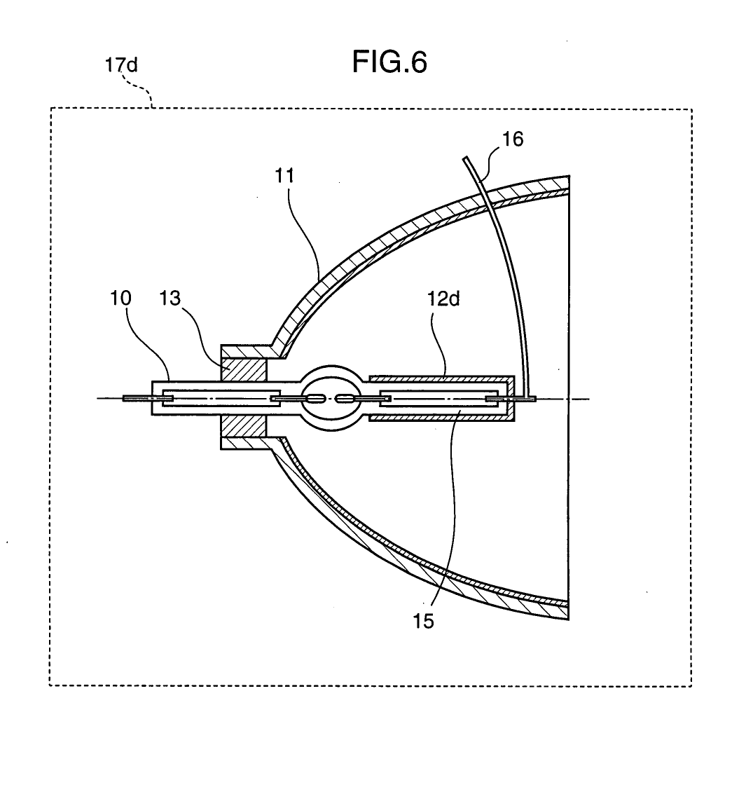

FIG. 6 is a schematic diagram showing a structure of a light source device according to Embodiment 5 of the present invention. A light source device 17d shown in FIG. 6 includes the discharge lamp 10, the ellipsoidal mirror 11, and a light shielding member 12d which is exemplary light shielding means. Components same as those in Embodiment 1 are denoted by same reference numerals, and will not be further described.

The light source device 17d shown in FIG. 6 is different from the light source device 17 shown in FIG. 1 in that the light shielding member 12d which covers the sealing portion 15 is employed instead of the light shielding member 12. The light shielding member 12d is formed by forming a dielectric multilayer film on an external surface of a tube with a bottom which is formed of heat-resistant plastic, ceramics, or the like. The light shielding member 12d is adhered to the sealing portion 15 using a highly heat-resistant adhesive or the like. The light shielding member 12d is placed in a portion of the area with no reflected light. As in Embodiment 1, of the returned light which illuminates the ellipsoidal mirror 11, the light shielding member 12d shields the light incident on the sealing portion 15 of the discharge lamp 10 almost completely and suppresses temperature rise of the portion.

In this example, even in the light source does not include the transmissive sealing member 18 shown in FIG. 3, the light shielding member 12d can be stably fixed. Since the light shielding member 12d covers almost the entire surface of the sealing portion 15, the light incident on the sealing portion 15 can be almost completely shielded. Thus, the heat-insulating effect can be further improved.

As described above, in the present embodiment, the light shielding member 12d which covers the sealing portion 15 shields the returned light almost completely even under the use circumstance where there is returned light to the ellipsoidal mirror 11. Thus, the temperature rise of the sealing portion 15 can be suppressed, and the light source device 17d with high reliability and the long life may be provided.

The light shielding member is not particularly limited to the above example. The light shielding member may be formed directly on the sealing portion 15, or may be may be formed to cover a part of the sealing portion 15, for example a part of an end of the sealing portion 15.

### Embodiment 6

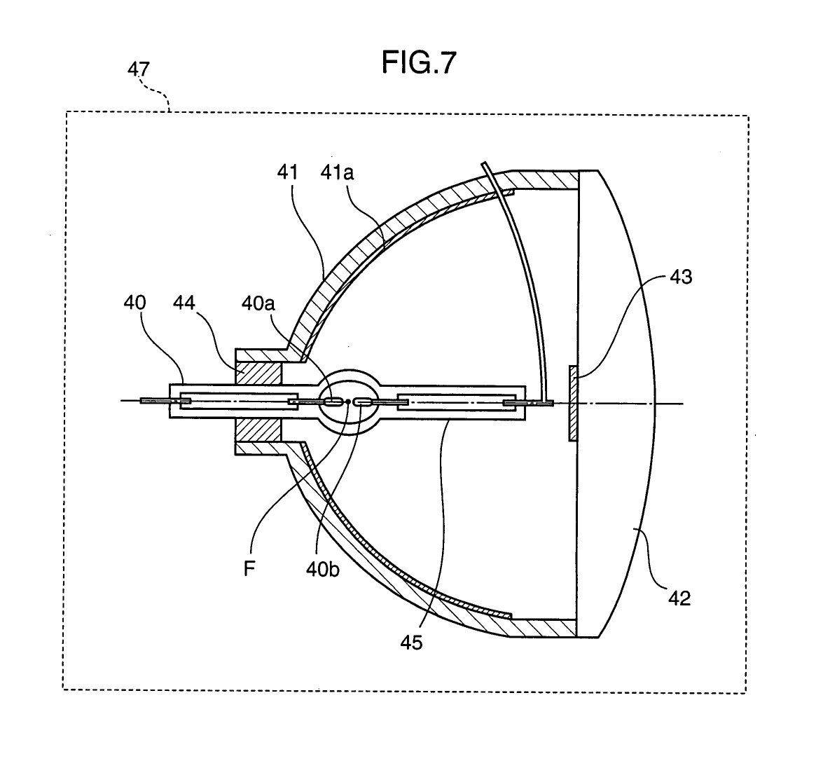

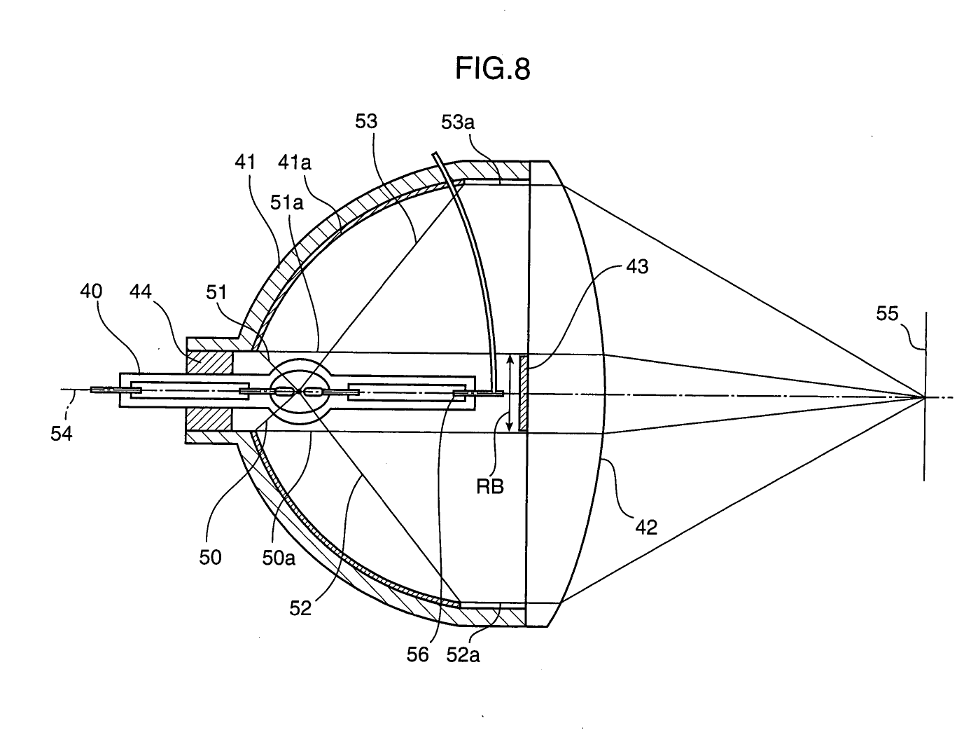

FIG. 7 is a partially sectional view showing a structure of a light source device according to Embodiment 6 of the present invention. FIG. 8 is a diagram of an optical path for illustrating a shielding effect in the light source device shown in FIG. 7. A light source device 47 shown in FIG. 7 includes a discharge lamp 40 which is exemplary light emitting means, a parabolic mirror 41 which is exemplary first condensing means, a plano-convex lens 42 which is exemplary second condensing means, and a light shielding member 43 which is exemplary shielding means.

A focal length F of the parabolic mirror 41 is 10 mm. On a reflection surface 41a of the parabolic mirror 41, a dielectric multilayer film for reflecting visible light efficiently and transmitting infrared rays is formed, and a visible light component of the light emitted from the discharge lamp 40 is efficiently reflected.

In the discharge lamp 40, which has a similar structure as the discharge lamp 10 shown in FIG. 1, a center of gravity of the light emitting portion formed between the electrodes 40a and 40b is placed at about the same position as the focus F of the parabolic mirror 41. The discharge lamp 40 is fixed to the parabolic mirror 41 by an adhesive material 44. In this way, light reflected by the reflection surface 41a becomes light proceeding in parallel with an optical axis 54, and exits from the parabolic mirror 41. The adhesive material 44 is preferably a material with a high heat resistance property. For example, inorganic heat resistant adhesives such as SUMICERAM® (available from Asahi Chemical Co., Ltd.) may be used.

The plano-convex lens 42 is placed at the exit opening portion of the parabolic mirror 41 and forms a substantially sealed space inside the parabolic mirror 41. In the present embodiment, the plano-convex lens 42 is employed as second condensing means. However, it is not limited to such an example, and various modifications can be made as long as it has a condensing function for the emitted light from the parabolic mirror 41. For example, biconvex lens, or a combination of a plurality of lenses may be used, or the surface which is closer to the parabolic mirror 41 may be shaped into a convex surface. In the present embodiment, the substantially sealed space is formed inside the parabolic mirror 41. However, it does not have to be the sealed space unless it is required particularly, and a vent hole or the like may be provided.

A light shielding effect of the light shielding member 43 will be described in detail with reference to FIG. 8. First, the light emitted from the discharge lamp 40 is reflected by the reflection surface 41a of the parabolic mirror 41 in predetermined directions. More specifically, light beams 50 and 51 are respectively reflected off as light beams 50a and 51a which proceed in a substantially parallel manner with the optical axis 54. Similarly, light beams 52 and 53 are respectively reflected off as light beams 52a and 53a which proceed in a substantially parallel manner with the optical axis 54. The light reflected by the reflection surface 41a of the parabolic mirror 41 are distributed in an area between the light beam 50a and the light beam 52a, and an area between the light beam 51a and the light beam 53a. Therefore, when the light is condensed using the parabolic mirror 41, there is an area RB with no reflected light. The area RB has a combined shape of a substantially tubular shape and a substantially conical shape.

The light shielding member 43 has a disc shape, and is placed in the area RB with no reflected light. Thus, the light shielding member 43 does not shield direct reflected light from the parabolic mirror 41 and can reflect a part of the reflected light which is reflected outside the light source device 47 and returns to the parabolic mirror 41.

For example, as shown in FIG. 8, when a diffusive reflection surface 55 is placed near the focus of the plano-convex lens 42, a part of the light incident on the reflection surface 55 is reflected in a direction toward the parabolic mirror 41. Of this reflected light, i.e., the light comes back to the parabolic mirror 41, the light shielding member 43 shields light incident on the sealing portion 45 of the discharge lamp 40. In this way, the temperature rise of the sealing portion 45 due to the returned light can be suppressed, and the reliability of the optical light source 47 can be improved.

The light shielding member 43 may be formed by forming a dielectric multilayer film for reflecting visible light on a surface of a transmissive plane glass. The light shielding member 43 also may be formed by forming a dielectric multilayer film which reflects ultraviolet rays, using glass which absorbs light of a particular wavelength, or using a medium which reflects light, such as aluminum foil, above-mentioned inorganic heat resistant adhesives (SUMICERAM®) or the like. The light shielding member 43 is not particularly limited to the above examples. Intended effects of the present invention can be achieved as long as the light shield member shields only the returned light without shielding the direct light from the parabolic mirror 41.

The light shielding member 43 is preferably placed between an end of the exit opening portion of the parabolic mirror 41 and the an end of the sealing portion 15. However, it may be placed between the end of the exit opening portion of the parabolic mirror 41 and the reflection surface 55. In such a case, it is preferable to be placed in an area closest to the parabolic mirror 41 among three areas obtained by equally dividing the space into three. More preferably, it is placed in an area closest to the parabolic mirror 41 among four areas obtained by equally dividing the space into four.

The size of the light shielding member 43 is preferably smaller than a size of a cross section of the area RB with no reflected light at the position where the light shielding member 12 is placed. In other words, a diameter of the light shielding member 43 is preferably smaller than a diameter of a circular cross section of the area RB. In such a case, a difference between the diameter of the light shielding member 43 and the diameter of the circular cross section of the area RB can be used as a margin for placing the light shielding member 43 to allow attachment and forming of the light shielding member 43 to be readily performed. The diameter of the light shielding member 43 may be larger than the diameter of the circular cross section of the area RB when there is a sufficient amount of light reflected by the parabolic mirror 41. In this case, a difference between the diameter of the light shielding member 43 and the diameter of the circular cross section of the area RB can be used as a margin for placing the light shielding member 43.

In the present embodiment, the light shielding member 43 having a disc shape is placed at a position where the center of the light shielding member 43 intersects the optical axis 54 of the parabolic mirror 41. However, the position of the light shielding member 43 is not limited to such an example, and the center may be placed at a position which is shifted from the optical axis 54, depending upon distribution of the returned light. For example, if the reflection surface 55 is tilted from the optical axis 54 and the returned light is shifted from the optical axis 54, the center may be placed at a position eccentric from the optical axis 54 in accordance with the shift. The light shielding member 43 is placed at a position appropriately set depending upon the application.

As described above, in the present embodiment, the light shielding member 43 provided on the plano-convex lens 42 which is placed near the exit opening portion of the parabolic mirror 41 shields the returned light even under the use circumstance where there is returned light to the parabolic mirror 41. Thus, the temperature rise of the sealing portion 45 can be suppressed, and the light source device 47 with high reliability and the long life may be provided.

In the embodiments described above, the ellipsoidal mirror and the parabolic mirror are respectively used as the condensing means and the first condensing means. However, the present invention is not particularly limited to such examples. A parabolic mirror may be used as the condensing means, or an ellipsoidal mirror may be used as the first condensing means. Alternatively, various types of mirrors such as reflective mirrors having non-spherical shape other than the ellipsoidal mirror and the parabolic mirror can be used as long as they can reflect the light emitted from a discharge lamp into predetermined directions and condense the light.

### Embodiment 7

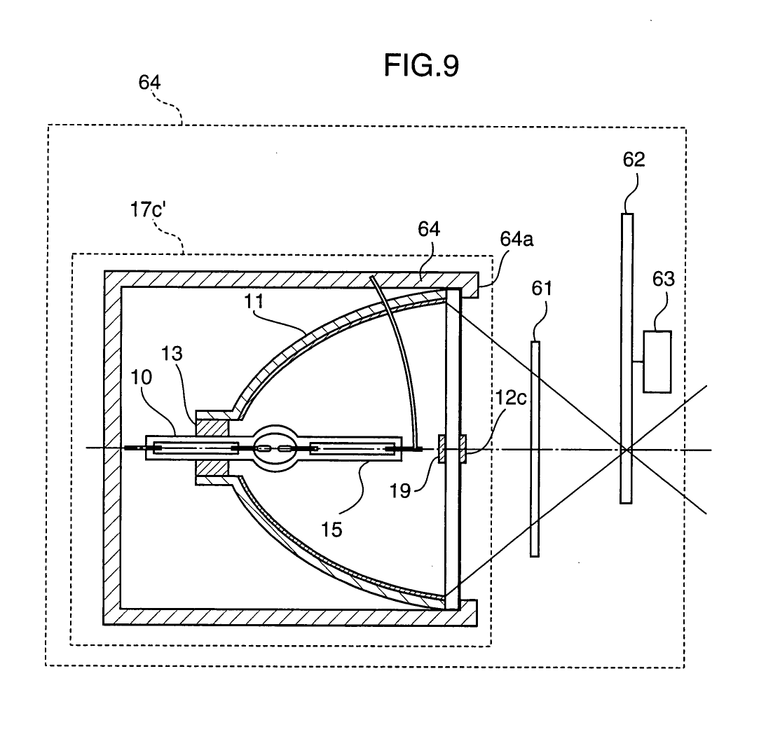

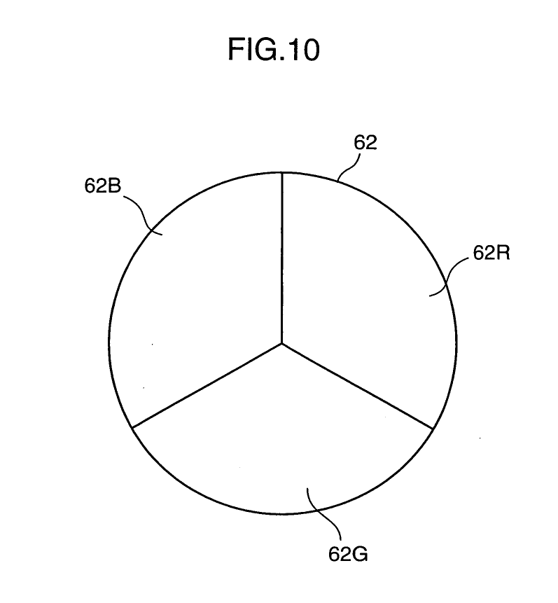

FIG. 9 is a partially sectional view showing a structure of an illumination optical device according to Embodiment 7 of the present invention. FIG. 10 is a schematic diagram showing a structure of a color selection member shown in FIG. 9. An illumination optical device 64 shown in FIG. 9 includes a light source device 17c′, a UV-IR cut filter 61, a color selection member 62 which is exemplary color selecting means, and a motor 63. The light source device 17c′ is a light source device 17c shown in FIG. 5, which further includes a housing 64, and other components are same as the light source device 17c. Thus, the same components are denoted by the same reference numerals and will not be described further. The light source device used in the illumination optical device 64 is not limited to this example, and any of the light source devices of the above embodiments may be used.

From light emitted from the light source device 17c′, ultraviolet rays and infrared rays are removed by the UV-IR cut filter 61. The color selection member 62 is placed near a position where the emitted light from the light source device 17c′ is condensed. The color selection member 62 is formed by combining a red color filter 62R, a green color filter 62G, and a blue color filter 62 which can selectively transmit light of red, green and blue bands as shown in FIG. 9. By rotating the motor 63 provided on a rotational axis of the color selection member 62, light of the red, green and blue bands can be switched timewise, and can be passed sequentially. The color selection member 62 is not limited to the above example, but various types of the color selection member such as single color filters for transmitting a certain band of wavelength, dimmer filters and the like may be used. Various types of the members can be used as the color selecting means of the present invention depending upon the properties, the shape, and a form of use.

Of the light which illuminates the color selection member 62, the light other than the transmissive band of the color filters 62R, 62G, and 62B is again reflected in directions toward the light source device 17c′. If the reflected light impinges upon the light source device 17c′, the returned light causes the temperature of the sealing portion 15 of the discharge lamp 10 to rise as described above. This may be the reason that the reliability of the light source device 17c′ is deteriorated.

Therefore, in the present invention, the light source device 17c′ includes the light shielding member 12c. The light shielding member 12c does not shield an effective light emitted from the light source device 17c′, and efficiently shields light incident on the sealing portion 15 of the discharge lamp from the reflected light which re-enters. Thus, the temperature rise at the sealing portion 15 can be suppressed. As a result, the reliability of the light source device 17c′ is increased, and the illumination optical device 64 with high reliability can be achieved.

The ultraviolet rays and the infrared light reflected by the UV-IR cut filter 61 also becomes the returned light and re-enters the light source device 60. They may cause the reliability of the light source device 17c′ to be deteriorated. Thus, the light shielding member 12c may be formed using a material which reflects not only visible light but also ultraviolet rays and infrared rays.

In the present embodiment, the light source device 17c shown in FIG. 5 is attached to the housing 64, and the housing 64 is formed such that it is detachable to the illumination optical device 64. The housing 64 is formed of plastics and the like, and has a substantially rectangular parallelepiped shape. Tip portions 64a of the housing 64 are protruded from a front face of the light source device 17c′, i.e., a surface of the light shielding member 12c by a predetermined length. The light shielding member 12c is placed at a position inward from the surface of the tip portions 64a by a predetermined distance. This allows a user to grasp the housing 64 for attaching or removing the light source device 17c′ while the light shielding member 12c is prevented from being damaged due to direct contact by the user to the light shielding member 12c. The light shielding member 12c can be securely protected.

### Embodiment 8

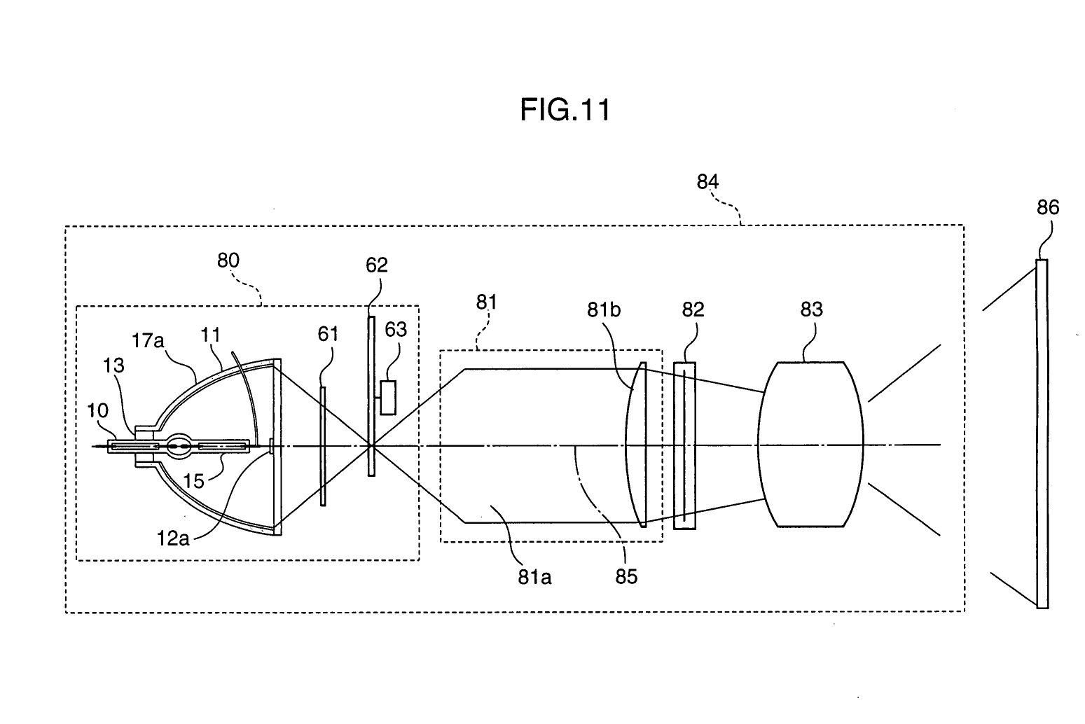

FIG. 11 is a schematic diagram showing a structure of a display device according to Embodiment 8 of the present invention. A display device 84 shown in FIG. 11 is a projection display device, which includes an illumination optical device 80, a condensing optical system 81, a transmissive liquid crystal panel 82 which is exemplary forming means, and a projection lens 83 which is exemplary projecting means.

The illumination optical device 80 is an illumination optical device 64 shown in FIG. 9 with the light source device being replaced with the light source device 17a shown in FIG. 3. The same components are denoted by the same reference numerals, and thus they will not be described further. The transmissive light of red, green, and blue emitted from the illumination optical device 80 impinges upon a condensing optical system 81. The condensing optical system 81 is formed of a condenser lens 81a and a field lens 81b. The condenser lens 81a converts divergence light emitted from the illumination optical device 80 into light which proceeds in a substantially parallel manner with an optical axis 85. The field lens 81b is used for effectively condensing the light passes through the liquid crystal panel 82 to the projection lens 83.

The emitted light of the illumination optical device 80 is condensed by the condensing optical system 81 and illuminates the liquid crystal panel 82. By synchronizing the illumination light of red, green and blue which is switched timewise and display of images on the liquid crystal panel 82, optical images which correspond to the red, green, and blue video signals are formed on the liquid crystal panel 82 being switched sequentially from one to another. The projection lens 83 expands the optical image on the liquid crystal panel 82 and projects on a screen 86. A large screen image displayed in full color is obtained.

According to the above structure, color images with a resolution as high as that in the three-plate type device can be achieved using one liquid crystal panel 82. Since it is no longer necessary to provide small color filters on the pixels on the liquid crystal panel 82, yield of the liquid crystal panel 82 will increase, and the cost of the projection display device can be reduced.

In the present embodiment, the light source device 17a of the illumination optical device 80 includes the light shielding member 12a. Thus, the light shielding member 12a does not shield an effective light emitted from the light source device 17c′, and can efficiently shields the light incident on the sealing portion 15 of the discharge lamp 10 of the reflected light which is re-entering. As a result, the temperature rise of the sealing portion 15 can be suppressed, and the reliability of the illumination optical device 80 using the light source device 17a can be improved. The small display device 84 with a high reliability can be realized.

In the above description, a transmissive liquid crystal panel is used as a spatial light modulating element. However, the present invention is not limited to such an example, and various types of the device such as a reflective liquid crystal panel, digital micromirror device (DMD) and the like may be used as long as they can spatially modulate illumination light to form an optical image. The display device to which the present invention is applied is not limited to the above example. For example, as will be described below, the display device may be applied as various types of display devices such as a rear projection display device and the like which has the projection display device accommodated inside the cabinet, and a display image can be watched through the transmissive screen attached to the cabinet.

### Embodiment 9

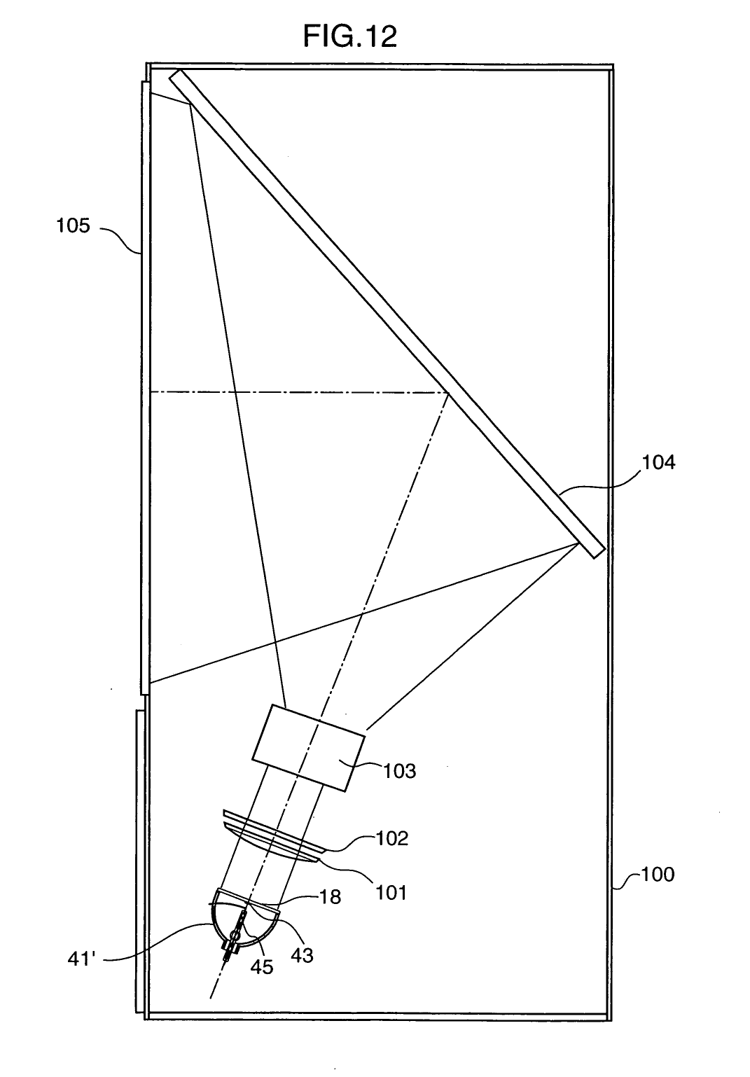

FIG. 12 is a schematic diagram showing a structure of a display device according to Embodiment 9 of the present invention. The display device shown in FIG. 12 is a rear projection display device which includes a light source device 41′, a field lens 101, a transmissive liquid crystal panel 102 which is exemplary forming means, a projection lens 103 which is exemplary projecting means, a reflecting mirror 104, and a screen 105.

The light source device 41′ is a light source device 41 shown in FIG. 8 with the plano-convex lens 42 on which the light shielding member 43 is formed is replaced with the transmissive sealing member 18 on which the light shielding member 43 is formed. Other components are same as those in the light source device 41 shown in FIG. 8. The same effects as the light shielding member 43 shown in FIG. 8 are achieved.

Light rays emitted from the light source device 41′ passes the field lens 101, and impinge upon the entire surface of the liquid crystal panel 102. The light rays are modulated, and the video information is added. The output light rays modulated at the liquid crystal panel 102 proceeds to the projection lens 103 where an optical image is expanded. The output light rays from the projection lens 103 are bent into a certain angle by the reflecting mirror 104 attached to a housing 100, and projected on the screen 105. The number of the light source devices 41′ is not particularly limited to the above example. Two or more light source devices may be used. Not only a single plate optical structure, but also other types of optical structures, such as three-plate optical structures and the like may be used.

In the present embodiment having the above described structure, the light source device 41′ includes the light shielding member 43. Thus, the light shielding member 43 does not shield the effective light emitted from the light source device 41′, and efficiently shields light incident on the sealing portion 45 of the discharge lamp of the re-entering light reflected by the field lens 101. As a result, temperature rise of the sealing portion 45 can be suppressed and the reliability of the light source device 41′ can be improved. Thus, a rear projection display device with high reliability can be realized.

### Embodiment 10

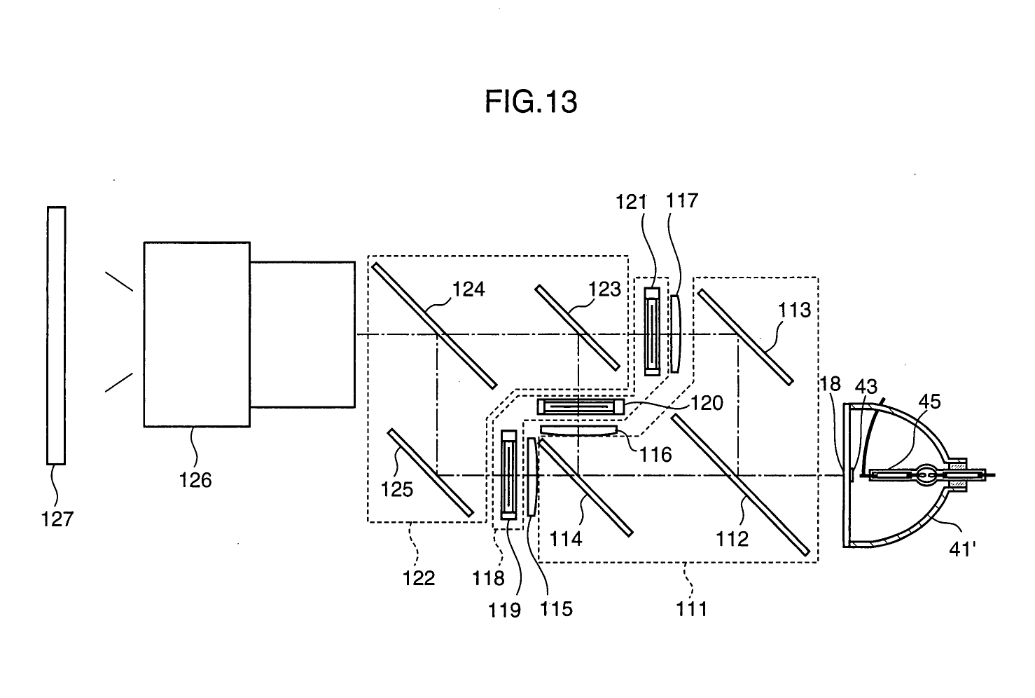

FIG. 13 is a schematic diagram showing a structure of a display device according to Embodiment 10 of the present invention. The display device shown in FIG. 13 is a three-plate projection display device of a mirror sequential method, which includes the light source device 41′, a color separation optical system 111, condenser lenses 115 through 117, a light valve portion 118 which is exemplary forming means, a color composition optical system 122, a projection optical system 126 which is exemplary projecting means. The color composition method in the display device is not particularly limited to a mirror sequential method, and other methods such as a cross prism method and the like may be used.

The color separation optical system 111 is formed of a blue reflection dichroic mirror 112, a reflecting mirror 113, and a green reflection dichroic mirror 114. The light valve portion 118 is formed of a red light valve unit 119, a green light valve unit 120, and a blue light valve unit 121. The color composition optical system 122 is formed of a green reflection dichroic mirror 123, a red reflection dichroic mirror 124, and a total reflection mirror 125.

The light source device 41′ is same as the light source device 41′ shown in FIG. 12, and has similar effects as the light shielding member 43 shown in FIG. 8. Light from the light source device 41′ impinges upon the color separation optical system 111. Of the incident light, blue light is reflected by the blue reflection dichroic mirror 112 and then off the reflecting mirror 113, and reaches the blue light valve unit 121 through the condenser lens 117.

Green light and red light passed through the color composition optical system 122 impinge upon the green reflection dichroic mirror 114. The green light is reflected by the green reflection dichroic mirror 114, and reaches the green light valve unit 120 through the condenser lens 116. The red light passes through the green reflection dichroic mirror 114, and reaches the red light valve unit 119 through the condenser lens 115.

The blue light valve unit 121, the green light valve unit 120 and the red light valve unit 119 are respectively formed of a polarizing plate on light entering side, a liquid crystal panel and a polarizing plate on light outgoing side. The polarizing plate on light entering side transmits light of a polarization direction in a lateral direction of an external shape, and is set to absorb light of a polarization direction orthogonal to such a light. The light passed through the polarizing plate on light entering side impinges upon the liquid crystal panel. The liquid crystal panel changes the polarization direction of the transmitted light for each of the openings of a number of pixels based on an external signal. When a pixel is not driven, the polarization direction is rotated by 90 degrees. When a pixel is driven, the light passes without the polarization direction being changed. The polarizing plate on light outgoing side has a polarization characteristic of a direction orthogonal to the polarizing plate on light entering side.

Thus, the polarization direction of the light passed the pixels for which the liquid crystal panel changes the polarization direction by 90 degrees matches a transmission axis of the polarizing plate on light outgoing side. Thus, the light passed the pixels for which the liquid crystal panel changes the polarization direction by 90 degrees passes the polarizing plate on light outgoing side. On the other hand, the polarization direction of the light passed the pixels for which the liquid crystal panel does not change the polarization direction is orthogonal to the transmission axis of the polarizing plate on light outgoing side. Thus, the light passed the pixels for which the liquid crystal panel changes the polarization direction is absorbed by the polarizing plate on light outgoing side.

The light passed through the light valve portion 118 as such impinges upon the color composition optical system 122. The light exit from the blue light valve unit 121 passes the green reflection dichroic mirror 123, and the red reflection dichroic mirror 124 and impinges upon the projection optical system 126. The light exit from the green light valve unit 120 is reflected by the green reflection dichroic mirror 123, and then, passes the red reflection dichroic mirror 124 to impinge upon the projection optical system 126. The light exit from the red light valve unit 119 is reflected by the total reflection mirror 125 and the red reflection dichroic mirror 124, and impinges upon the projection optical system 126. The projection optical system 126 expands the image on the light valves and projects on the screen 127.

In the present embodiment having the above-described structure, the light source device 41′ includes the light shielding member 43. Thus, the light shielding member 43 does not shield the effective light emitted from the light source device 41′ and can efficiently shield light incident on the sealing portion 45 of the discharge lamp of the reflected light which is reflected by the condenser lenses 115 through 117 and re-enters. As a result, temperature rise at the sealing portion 45 can be suppressed, and the reliability of the light source device 41′ is improved. Thus, a three-plate projection display device with high reliability can be realized.

### Embodiment 11

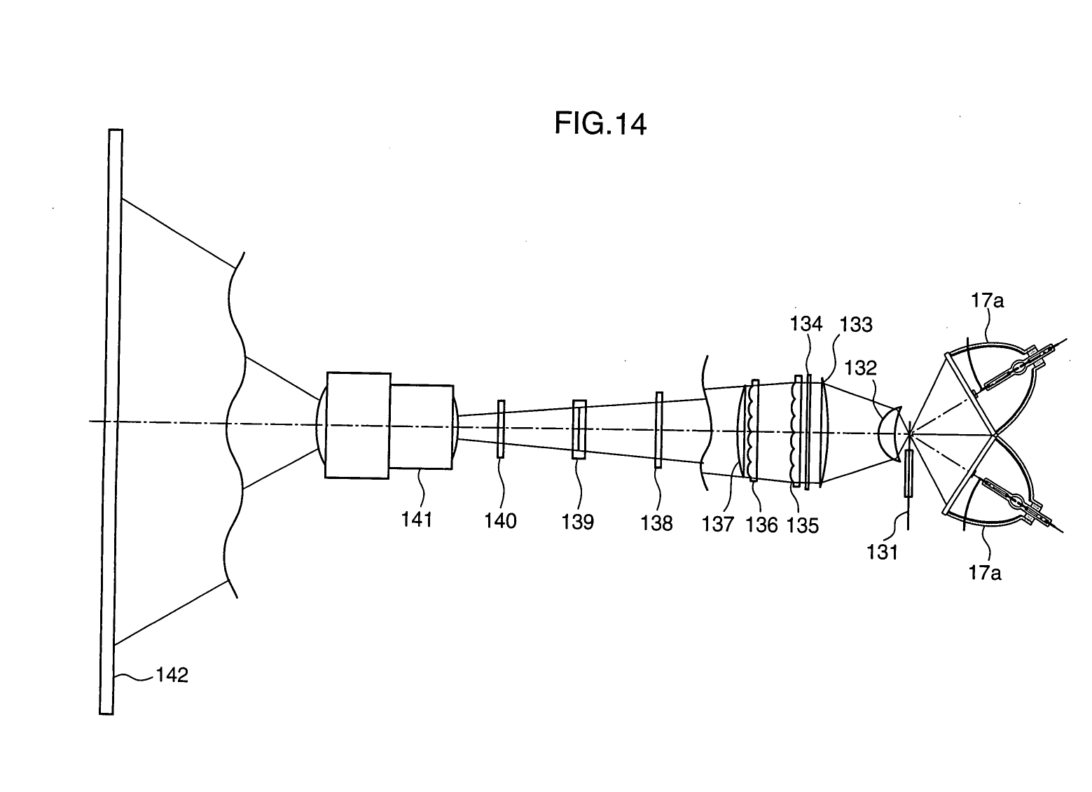

FIG. 14 is a schematic diagram showing a structure of a display device according to Embodiment 11 of the present invention. The display device shown in FIG. 14 is a projection display device using a plurality of light sources, which includes two light sources 17a, a color selection member 131, condenser lenses 132 and 133, UV-IR cut filter 134, a first lens array 135, a second lens array 136, a polarizer 138, a transmissive liquid crystal panel 139 which is exemplary forming means, an analyzer 140, and a projection optical system 141 which is exemplary projection means. The number of the light source is not limited to the above example, and three or more light sources may be used.

The light sources 17a are respectively same as the light source 17a shown in FIG. 3, has similar functions as the light shielding member 12a shown in FIG. 3. Two light sources 17a are placed such that their optical axes intersect at the second focus. At the intersection of their optical axes, the color selection member 131 is placed as shown in the figure. The color selection member 131 has a similar structure as the color selection member 62 shown in FIG. 10.

The light passes through the color selection member 131 become substantially parallel light after passing through the condenser lenses 132 and 133. Then, the light passes through the UV-IR cut filter 134, and impinges upon a first lens array 135 with a number of microlenses being formed.

A second lens array 136 is placed at the second light source position formed for the microlenses of the first lens array 135. There are a number of microlenses placed at the position of the light source image to form the second lens array 136. These microlenses are formed to expand the shape of the openings of the microlenses of the first lens array 135 and to project on the liquid crystal panel 139. The images of the microlenses of the first lens array 135 are overlapped to have uniform illumination.

The light passed through the first lens array 135 and the second lens array 136 impinges upon the condensing lens 137. The light passed through the condensing lens 137 impinges upon the polarizer 138. At the polarizer 138, a polarization light component in an absorption axis direction is absorbed and only a polarization light component in the orthogonal direction is transmitted and impinges upon the liquid crystal panel 139.

The liquid crystal panel 139 is formed of a number of pixels which can be modulated independently based on an input signal from outside. Of the light impinges upon the liquid crystal panel 139, light impinges upon the pixel portions which have to be displayed black have the polarization direction changed by 90 degrees when it passes and exits from the liquid crystal panel 139. The light is set to be absorbed by the analyzer 140. On the other hand, light impinges upon the pixel portions which have to be displayed white have the polarization direction being unchanged when it passes and exits from the liquid crystal panel 139. The light passes through the analyzer 140 and impinges upon the projection optical system 141. An image of the transmissive liquid crystal panel 139 is expanded and projected on the screen 142.

In the present embodiment having the above structure, each of the light sources 17a includes the light shielding member 12a. Thus, the light shielding members 12a do not shield the effective light emitted from the light source devices 17a and can efficiently shield light incident on the sealing portion 15 (see FIG. 3) of the discharge lamp of the reflected light which is reflected by the color selection member 131 and re-enters. As a result, temperature rise at the sealing portion 15 can be suppressed, and the reliability of all the light sources 17a is improved.

The present invention may be applied not only to the display device as described above but also to various devices using light sources such as exposure devices used for manufacturing a semiconductor and the like. The features of the above embodiments can be combined in any manner as necessary, and still the effects of such features can be achieved.

### INDUSTRIAL APPLICABILITY

The light source device according to the present invention can prevent the life of the light emitting means from being shortened due to returned light even under a use circumstance with the returned light to the light source device. Thus, the light source device with high reliability can be realized, and the light source device is applicable as a light source device using a discharge lamp or the like as light emitting means.

1-27. (canceled)

28. A light source device, comprising:
a light emitting member which serves as a light source;
a first reflecting member for reflecting light emitted from the light emitting member, and outputting the light to the outside;
a second reflecting member for reflecting at least a part of the light emitted from the first reflecting member to the outside; and
a light shielding member for shielding at least a part of light, which is reflected by the second reflecting member and returns toward the light emitting member.

29. A light source device according to claim 28, wherein:
the light emitting member includes a discharge lamp;
the first reflecting member includes a condensing member for reflecting the light emitted from the discharge lamp and outputting the light to the outside such that the light emitted from the discharge lamp is condensed to a predetermined position; and
the light shielding member shields at least a part of light, which is reflected by the second reflecting member and returns toward the discharge lamp, of the light condensed and emitted to the outside by the condensing member.

30. A light source device according to claim 29, wherein the light shielding member is provided near an opening portion of the condensing member.

31. A light source device according to claim 29, wherein the light shielding member is placed between an opening portion of the condensing member and the discharge lamp.

32. A light source device according to claim 29, wherein the light shielding member is fixed to a lead wire of the discharge lamp which is positioned on an opening portion side of the condensing member.

33. A light source device according to claim 29, wherein the light shielding member is provided on an end portion of the discharge lamp which is positioned on an opening portion side of the condensing member.

34. A light source device according to claim 29, wherein the light shielding member covers a sealing portion of the discharge lamp which is positioned on an opening portion side of the condensing member.

35. A light source device according to claim 29, further comprising an absorbing member which is placed between the light shielding member and the discharge lamp and absorbs the light emitted from the discharge lamp.

36. A light source device according to claim 29, further comprising a transmissive sealing member which is placed at the opening portion of the condensing member and forms a substantially sealed space inside the condensing member, wherein
the light shielding member is provided on the transmissive sealing member.

37. A light source device according to claim 36, wherein the light shielding member is provided on a surface of the transmissive sealing member on a side of the discharge lamp.

38. A light source device according to claim 36, wherein the light shielding member is provided on a surface of the transmissive sealing member on a side opposite to the discharge lamp.

39. A light source device according to claim 38, further comprising an absorbing member which is provided on a surface of the transmissive sealing member on a side of the discharge lamp and absorbs the light emitted from the discharge lamp.

40. A light source device according to claim 36, wherein the transmissive sealing member is a plane glass.

41. A light source device according to claim 29, wherein the condensing member is an ellipsoidal mirror.

42. A light source device according to claim 29, wherein the condensing member is a parabolic mirror.

43. A light source device according to claim 28, wherein:
the light emitting member includes a discharge lamp;
the first reflecting member includes
a first condensing member for reflecting the light emitted from the discharge lamp in predetermined directions, and
a second condensing member for condensing the light emitted from the first condensing member to a predetermined position; and
the light shielding member shields at least a part of light, which is reflected by the second reflecting member and returns toward the discharge lamp, of the light condensed and emitted to the outside by the second condensing member.

44. A light source device according to claim 43, wherein the light shielding member is provided near the second condensing member.

45. A light source device according to claim 43, wherein the light shielding member is provided on the second condensing member.

46. A light source device according to claim 43, wherein the light shielding member is placed between the second condensing member and the discharge lamp.

47. A light source device according to claim 43, wherein the first condensing member is a parabolic mirror.

48. A light source device according to claim 43, wherein the first condensing member is an ellipsoidal mirror.

49. A light source device according to claim 43, wherein:
the second condensing member is a plano-convex lens; and
the light shielding member is provided on a surface of the plano-convex lens on a side of the discharge lamp.

50. A light source device according to claim 28, wherein the light shielding member is formed of a multilayer film which reflects at least one of infrared rays and ultraviolet rays.

51. A light source device according to claim 28, wherein the light shielding member reflects visible light.

52. A light source device according to claim 28, wherein the light shielding member is placed in an area with no light reflected by the first reflecting member.

53. An illumination optical device, comprising:
a light source device according to claim 29, in which
the second reflecting member is a light selecting member which is placed near a condensing position of light emitted from the light source device and selectively transmits light having a predetermined wavelength of the light emitted from the light source device.

54. A display device, comprising:
a light source device according to claim 28;
a forming unit for forming an optical image corresponding to a video signal by using the light emitted from the light source device; and
a projecting unit for projecting the optical image formed by the forming unit on a screen.
